(19) United States
(12) Patent Application Publication
(10) Pub. No.: US 2005/0089173 A1
(43) Pub. Date: Apr. 28, 2005

(54) Trusted authority for identifier-based cryptography

(76) Inventors: Keith Alexander Harrison, Woodcroft Chepstow (GB); Liqun Chen, Bradley Stoke Bristol (GB); John Malone-Lee, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/893,571

(22) Filed: Jul. 15, 2004

Related U.S. Application Data
(63) Continuation-in-part of application No. 10/613,522, filed on Jul. 2, 2003.

(30) Foreign Application Priority Data
Jul. 5, 2002 (GB) 0215590.1

(51) Int. Cl. H04L 9/00

(52) U.S. Cl. 380/277

(57) ABSTRACT

A trusted authority is provided for identifier-based cryptography. The trusted authority has a secret and derives first and second elements at least the second of which it publishes. The first element is derived from an identifier associated with the trusted authority; the second element is a combination of the first element and the secret. The trusted authority provides a private-key generation service involving the generation of a private key for a third party in dependence on the secret and an identifier string associated with that third party.

### FIELD OF THE INVENTION

The present invention relates to a trusted authority for identifier-based cryptography. As used herein, the term “trusted authority” means an entity that is trustable to make available an identifier-based private key to a third party, or its proxy, only when satisfied that the third party is entitled to the key (in certain cases, the trusted authority may act as a proxy for the third party).

### BACKGROUND OF THE INVENTION

As is well known to persons skilled in the art, in “identifier-based” cryptographic methods a public, cryptographically unconstrained, string is used in conjunction with public data of a trusted authority to carry out tasks such as data encryption or signing. The complementary tasks, such as decryption and signature verification, require the involvement of the trusted authority to carry out computation based on the public string and its own private data. Frequently, the string serves to “identify” the intended message recipient and this has given rise to the use of the label “identifier-based” or “identity-based” generally for these cryptographic methods. However, depending on the application to which such a cryptographic method is put, the string may serve a different purpose to that of identifying the intended recipient and, indeed, may be an arbitrary string having no other purpose than to form the basis of the cryptographic processes. Accordingly, the use herein of the term “identifier-based”, or “IB”, in relation to cryptographic methods and systems is to be understood simply as implying that the methods and systems are based on the use of a cryptographically unconstrained string whether or not the string serves to identify the intended recipient.

A number of different identifier-based cryptographic techniques are known, three of the most well known being:
Quadratic Residuosity as described in the paper: C. Cocks, “An identity based encryption scheme based on quadratic residues”, Proceedings of the 8^{th} IMA International Conference on Cryptography and Coding, LNCS 2260, pp 360-363, Springer-Verlag, 2001.
Bilinear Mappings p using, for example, a modified Tate pairing or modified Weil pairing; details of these pairings and their cryptographic uses can be found in the following references:
   G. Frey, M. Müiller, and H. Rück. The Tate pairing and the discrete logarithm applied to elliptic curve cryptosystems. IEEE Transactions on Information Theory, 45(5):1717-1719, 1999.
   D. Boneh and M. Franklin. Identity based encryption from the Weil pairing. In Advances in Cryptology—CRYPTO 2001, LNCS 2139, pp. 213-229, Springer-Verlag, 2001.
RSA-Based; an IB encryption method based on mediated RSA is described in the paper “Identity based encryption using mediated RSA”, D. Boneh, X. Ding and G. Tsudik, 3rd Workshop on Information Security Application, Jeju Island, Korea, August, 2002. A non-mediated RSA-based IB method is described in U.S. Pat. No. 6,275,936 where the decryption exponent is dynamically computed from the encryption exponent, the latter being a hash of the sender-chosen string.
ElGamal-Based; an IB encryption method based on the ElGamal cryptosystem is described in our UK patent application No.: GB 0413056.3 filed Jun. 11, 2004.

As preferred embodiment of the present invention use bilinear mappings for implementing identifier-based cryptography, a brief description will now be given of this approach.

In the present specification, G₁ and G₂ denote two algebraic groups of large prime order l in which the discrete logarithm problem is believed to be hard and for which there exists a non-degenerate computable bilinear map p, for example, a Tate pairing or Weil pairing. Note that G₁ is a [l]-torsion subgroup of a larger algebraic group G₀ and satisfies [l]P=O for all P ε G₁ where O is the identity element, l is a large prime, and l*cofactor=number of elements in G₀. The group G₂ is a subgroup of a multiplicative group of a finite field.

For the Weil pairing:, the bilinear map p is expressed as
p: G₁×G₁→G₂.

The Tate pairing can be similarly expressed though it is possible for it to be of asymmetric form:
p: G₁×G₀→G₂

Generally, the elements of the groups G₀ and G₁ are points on an elliptic curve (typically, though not necessarily, a supersingular elliptic curve); however, this is not necessarily the case.

For convenience, the examples given below assume the use of a symmetric bilinear map (p: G₁×G₁→G₂) with the elements of G₁ being points on an elliptic curve; however, these particularities, are not to be taken as limitations on the scope of the present invention.

As is well known to persons skilled in the art, for cryptographic purposes, modified forms of the Weil and Tate pairings are used that ensure p(P,P)≠1 where P ε G₁; however, for convenience, the pairings are referred to below simply by their usual names without labeling them as modified.

As the mapping between G₁ and G₂ is bilinear, exponents/multipliers can be moved around. For example if a, b, c ε Z (where Z is the set of all integers) and P, Q ε G₁ then

$$\begin{matrix}{p ( aP , bQ )}^{c} = {p ( aP , cQ )}^{b} = {p ( bP , cQ )}^{a} = {p ( bP , aQ )}^{c} = {p ( cP , aQ )}^{b} \\ = {p ( cP , bQ )}^{a} = {p ( abP , Q )}^{c} = p ( abP , cQ ) = {p ( P , abQ )}^{c} \\ = p ( cP , abQ ) \\ = … \\ = p ( abcP , Q ) = p ( P , abcQ ) = {p ( P , Q )}^{abc}\end{matrix}$$

Additionally, the following cryptographic hash functions are defined:
H₁: {0,1)*→G₁
H₂: {0,1)*→Z*ₗ
H₃: G₂→{0,1)*

The function H₁( ) is often referred to as the mapToPoint function as it serves to convert a string input to a point on the elliptic curve being used.

A normal public/private key pair can be defined for a trusted authority:
the private key is s
where S ε Zₗ and
the public key is (P, R)
where P and R are respectively master and derived public elements with P ε G₁ and R ε G₁, P and R being related by R=sP.

Additionally, an identifier based public key/private key pair can be defined for a party with the cooperation of the trusted authority. In the present case, the identifier-based public/private key pair defined for the party has a public key Q_{ID} and private key S_{ID} where Q_{ID}, S_{ID} ε G₁. The trusted authority's normal public/private key pair (P, R/s) is linked with the identifier-based public/private key by
S_{ID}=sQ_{ID} and Q_{ID}=H₁(ID)
where ID is the identifier string for the party.

Some typical uses for the above described key pairs will now be given with reference to FIG. 1 of the accompanying drawings that depicts a trusted authority 11 with a public key (P, sP) and a private key s. A party A serves as a general third party whilst for the identifier-based cryptographic tasks (IBC) described, a party B has an IBC public key Q_{ID} and an IBC private key S_{ID}, this latter key being generated by private-key generation functionality 12 of the trusted authority 11 from the identifier ID of party B. The trusted authority will generally only provide the party B with its private key after having checked that party B is entitled to the identifier ID (for example, by having verified that party B meets certain conditions specified in the identifier, such as an identity condition).

Identifier-Based Encryption (see dashed box 13):—Identifier based encryption allows the holder of the private key S_{ID} of an identifier based key pair (in this case, party B) to decrypt a message sent to them encrypted (by party A) using B's public key Q_{ID}.

More particularly, party A, in order to encrypt a message m, first computes:
U=rP
where r is a random element of Z*ₗ. Next, party A computes:
V=m⊕H₃(p(R, rQ_{ID}))

Party A now has the ciphertext elements U and V which it sends to party B.

Decryption of the message by party B is performed by computing:

$$\begin{matrix}V ⊕ {H}_{3} ( p ( U , {S}_{ID} ) ) = V ⊕ {H}_{3} ( p ( rP , {sQ}_{ID} ) ) \\ = V ⊕ {H}_{3} ( {p ( P , {Q}_{ID} )}^{rs} ) \\ = V ⊕ {H}_{3} ( p ( sP , {rQ}_{ID} ) ) \\ = V ⊕ {H}_{3} ( p ( R , {rQ}_{ID} ) ) \\ = m\end{matrix}$$

The foregoing example encryption scheme is the “BasicIdent” scheme described in the above-referenced paper by D. Boneh and M. Franklin. As noted in that paper, this basic scheme is not secure against a chosen ciphertext attack (the scheme only being described to facilitate an understanding of the principles involved—a fully secure scheme is described later on in the paper and the reader should refer to the paper for details).

Identifier-Based Signatures (see dashed box 14):—Identifier based signatures using pairings can be implemented. For example:

Party B first computes:
r=p(S_{ID}, p)^{k}
where k is a random element of Z*ₗ.

Party B then apply the hash function H₂ to m∥r (concatenation of m and r) to obtain:
h=H₂(m∥r).

Thereafter party B computes
U=(k−h)S_{ID}
thus generating the output U and h as the signature on the message m.

Verification of the signature by party A can be established by computing:
r′=p(U, P)·p(Q_{ID}, R)^{h}
where the signature can only be accepted if h=H₂ (m∥r′).

### SUMMARY OF THE INVENTION

According to a first aspect of the present invention, there is provided an identifier-based cryptographic method, comprising a trusted authority, with a secret and an associated identifier string, carrying out operations of:
deriving a first element from said identifier string using a one-way mapping function;
deriving a second element using the secret and the first element;
making at least the second element publicly available; and
providing a private-key generation service comprising generating a private key for a third party in dependence on said secret s and on an identifier string associated with that third party.

In all previous publications and known implementations of a trusted authority for identifier-based cryptography using bilinear maps, it has been assumed that the trusted authority simply chooses its first element P. It has now been found that by deriving this point from an identifier string, certain benefits accrue that outweigh the computational and organisational costs involved.

The present invention also encompasses apparatus and computer program products.

### BRIEF DESCRIPTION OF THE DRAWINGS

Embodiments of the invention will now be described, by way of non-limiting example, with reference to the accompanying diagrammatic drawings, in which:

FIG. 1 is a diagram showing prior art cryptographic processes based on elliptic curve cryptography using pairings;

FIG. 2 is a diagram illustrating a preferred form of mapToPoint function used in the first and second embodiments of the present invention;

FIG. 3 is a diagram of a first embodiment, this embodiment using bilinear maps and involving a hierarchy of a first-level trusted authority and a second-level trusted authority;

FIG. 4 is a diagram of a second embodiment, this embodiment using bilinear maps and involving two independent trusted authorities; and

FIG. 5 is a diagram of an ElGamal-based third embodiment.

### BEST MODE OF CARRYING OUT THE INVENTION

In the following description, G₁, G₂ are two groups of large prime order l for which there exists a non-degenerate computable bilinear map p: G₁×G₁→G₂ whereby for all P₁, P₂ ε G₁ and all integers a and b:
p(aP₁, bP₂)=p(P₁, P₂)^{ab}.

The construction for such groups normally (though not necessarily) uses supersingular elliptic curves over finite fields F_{q} (where q is a prime power) and the use of such a curve will be assumed here (the curve y²=x³+1 being used as an example). The corresponding bilinear map is a modification of the Weil/Tate pairing. Note that G₁ is a [l]-torsion group satisfying [l]P=O for all P ε G₁ where O is the infinite element, l is a large prime, and l *cofactor=number of points on curve in F_{q}.

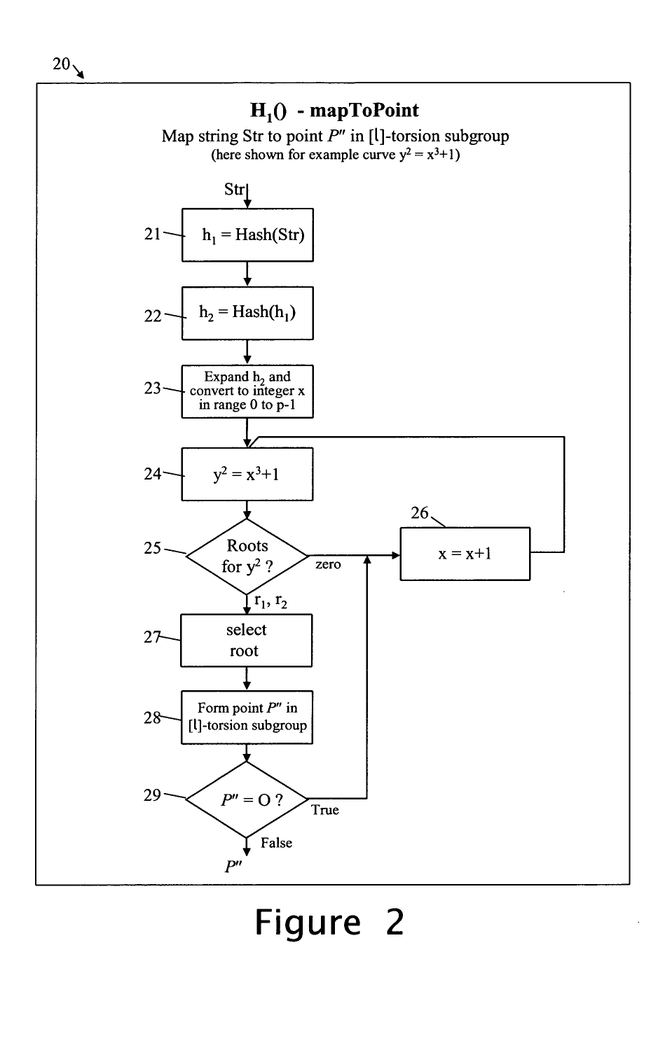

The first two embodiments of the present invention both use a mapToPoint one-way function H₁( ) to derive a point P on the chosen elliptic curve from an input identifier string Str. Whilst a number of implementations of such a function are known in the art, a preferred form will next be described with reference to FIG. 2 which shows H₁ as a number of steps 21 to 29 as follows:
Step 21 A standard hash function (such as SHA-512) is used to hash the input string Str whereby to form another string hi which is temporarily stored;
Step 22 A copy of the string h₁ is hashed again to form the string h₂;
Step 23 The string h₂ is expanded to size p (for example, using MGF1) and converted to an integer ‘x’ in the range 0 to p-1;
Step 24 The quantity y² is formed by putting the value x into the equation of the chosen elliptic curve (here, y²=x³+1);
Step 25 The quantity y² is tested (using the Jacobi function) to determine if it has a pair of roots (r₁, r₂) or zero roots;
Step 26 If no roots are found in step 25, the value of x is incremented and processing resumes at step 24;
Step 27 If a pair of roots is found in step 25, one of these roots is selected to be the value of y—this random selection is achieved by looking at the last bit of h₁ treated as an integer α, more particularly:
   y=r₁ if α mod 2≡r₁ mod 2, otherwise y=r₂
Step 28 The values of x and y obtained by the foregoing steps are then used to construct a point P′ on the elliptic curve and this point is multiplied by the cofactor value of l, where [l*cofactor]P′=O, in order to derive a point P″ in the [l]-torsion group;
Step 29 A check is made as to whether P″=O and if so, processing continues at step 26; otherwise P″ is output as the point mapped from the string Str.

As already indicated, the present invention concerns trusted authorities for use in identifier-based cryptography based on bilinear maps. In the embodiments described below, such a trusted authority has a private key in the form of a secret s, and a public key (P, R) where P and R are points on a chosen elliptic curve with points in G₁, and R=sP. The trusted authority comprises private-key generation functionality for generating a private key S for a user by combining an identity ID of the user with the secret s:
S=sH₁(ID)

This private key is generally only made available to the user (or the user's proxy) after appropriate actions have been taken in respect of the identity ID, such as to check the entitlement of the user concerned to that identity or to check any other conditions that may be specified in the ID string. The ID string serves as the public key of the user.

The point P of the trusted authority is itself derived from an identifier string by use of a mapToPoint one-way function such as described above with reference to FIG. 2. This identifier string can be chosen at random or as any meaningful information of the trusted authority (for example, a contact address such as the URL of a website of the trusted authority) together with a definition of the identifier string (e.g. encryption key string) formats that it accepts from users for private key generation. Providing such meaningful information in the string from which P can be generated by any party gives a convenient way of distributing such information.

Other advantages also arise from having the trusted authority generate its point P from a string, including:
since the trusted authority cannot control the outcome of the mapToPoint function, it is not possible for the trusted authority to maliciously choose its point P for cryptographic (dis)advantage;
where there are multiple trusted authorities, if all such authorities generate their respective points Pᵢ from different identifier strings, it ensures that the points are unrelated (since the mapToPoint function includes random hashing) which is required for certain cryptographic methods involving multiple trusted authorities.

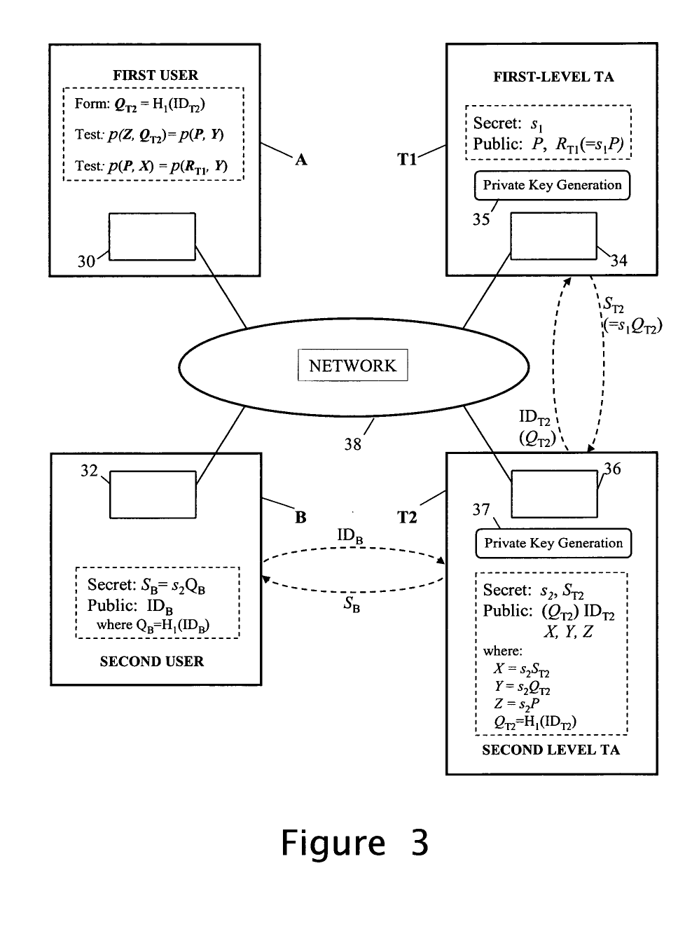

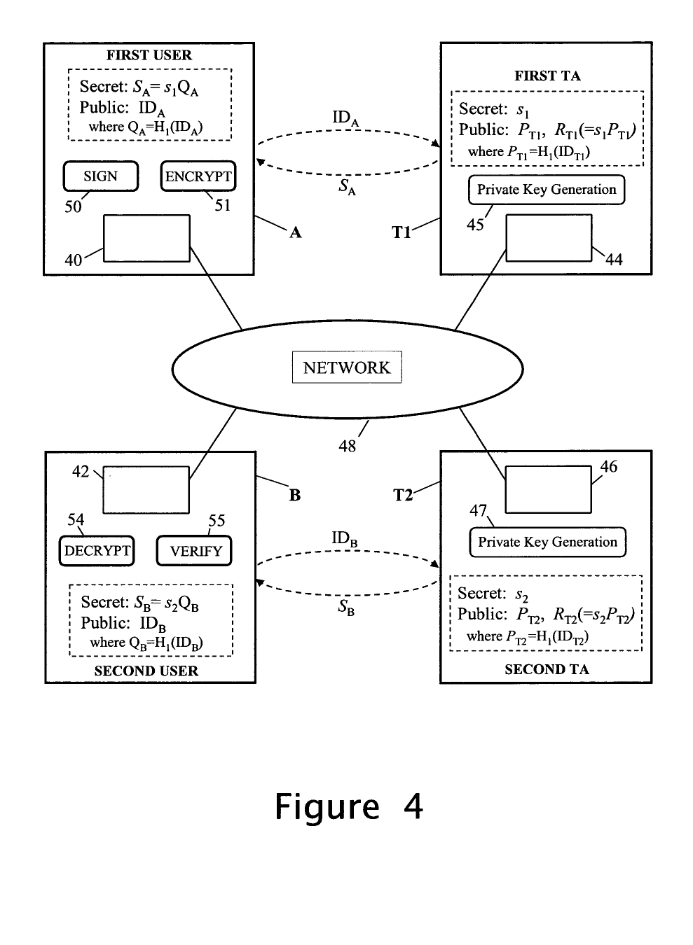

An example of each of the above two types of situations will now be given with reference to FIGS. 3 and 4 respectively.

In the FIG. 3 embodiment, four parties are depicted, namely a first user A acting through computing entity 30, a second user B acting through computing entity 32, a first trusted authority T1 acting through computing entity 34 that provides private-key generation functionality 35, and a second trusted authority T2 acting through computing entity 36 that provides private-key generation functionality 37. The computing entities 30, 32, 34 and 36 are typically based around program-controlled processors though some or all of the cryptographic functions may be implemented in dedicated hardware. The entities 30, 32, 34 and 36 inter-communicate, for example, via the internet or other computer network 38 though it is also possible that two, three or all four entities actually reside on the same computing platform. For convenience, the following description is given in terms of the parties A, B, T1 and T2, it being understood that these parties act through their respective computing entities.

The first trusted authority T1 and second trusted authority T2 form a trusted authority hierarchy in which the first trusted authority T1 acts as a root, or first level, trusted authority and the second trusted authority T2 acts as a second level trusted authority. The first-level trusted authority T1 has a standard public key (P, R_{T1})/private key (s₁) key pair where R_{T1}=s₁P and s₁ is a secret. For the purposes of discussion, the second-level trusted authority T2 is initially taken also to have a standard public key (Q_{T2}, Y)/private key (s₂) key pair where Y=s₂Q_{T2} and s₂ is a secret; as will be seen, the public/private parameters of T2 are subsequently modified to meet certain risks.

The second user B has an associated public identity string ID_{B} and a private key S_{B} which has been, or can be, generated by the functionality 37 of the second-level trusted authority T2 using T2's secret s₂ and Q_{B}, where Q_{B}=H₁(ID_{B}).

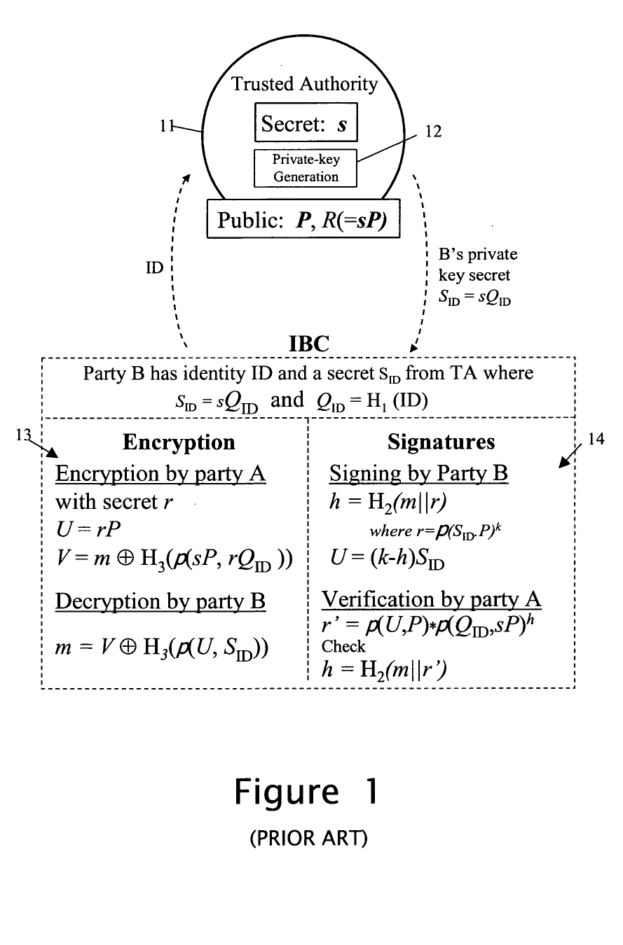

The first user A can encrypt a message and send it to second user B using a specific instance of the identity string ID_{B} chosen by user A and the public key of the second trusted authority (in this example, B is assumed only to be registered with T2 and not T1 so user A must use T2's public key). The user B can obtain the corresponding instance of the private key S_{B} from the trusted authority T2. The details of the encryption scheme used are not of importance for the purposes of the present discussion though one possible scheme is that shown in box 13 of FIG. 1.

There could be a problem, however, because the first user A may not know whether the second trusted authority T2 is, in fact, trustworthy. It will be assumed this is the case but that user A does trust the trusted authority T1 and is willing to trust any trusted authority associated with T1. Therefore, the user A wishes to ascertain whether T2 is associated with T1.

To this end, the first trusted authority T1 provides the second trusted authority T2 with a secret S_{T2} for establishing the existence of an association between T1 and T2 where:
S_{T2}=s₁Q_{T2}

The secret S_{T2} is used by T2 to generate verification parameters for enabling the first user A (or, indeed, any party) to verify that T1 and T2 are associated without the secret S_{T2} being given away. More particularly, T2 multiplies S_{T2} by s₂ and makes the resulting combination X public.

Recapping so far, the elements associated with the first and second trusted authorities are:
First trusted authority T1:
   Secret data: s₁
   Public data: P, R_{T1}(=s₁P)
Second trusted authority T2:
   Secret Data: s₂, S_{T2} (=s₁Q_{T2})
   Public data: Q_{T2}, Y (=s₂Q_{T2}), X(=s₂S_{T2})

It is assumed that the user A reliably knows P and R_{T1}(=s₁P), the public data of the first trusted authority T1. The user A has also received, in respect of the second trusted authority T2: the point Q_{T2}; an element, herein called X′, that is purportedly X; and an element, herein called Y′ that is purportedly Y. In order to check whether X′ truly does contain s₁ (as it would if truly X); the user A checks the following:
p(P, X′)=p(R_{T1}, Y′) Test 1

Because R_{T1}=s₁P, the above will only be valid if X′ is equal to s₁Y′. This would prove that the second trusted authority T2 must have a shared secret containing s₁ which only it and the first trusted authority know (thus proving the association between the trusted authorities) were it not for the possibility that, since s₁P is public, the second trusted authority T2 could have constructed Q_{T2} as mP, where m ε F_{q}, and then used m, s₂ and s₁P to construct X as s₁s₂mP and Y as s₂mP. In other words, if the second trusted authority T2 can construct its point Q_{T2} from P then, it can pass Test 1 without needing to ask for a shared secret from the first trusted authority.

It is therefore necessary for the user A to be satisfied that Q_{T2} has not been formed by multiplying P by m (it being appreciated that because the discrete logarithm problem is hard, the user A cannot discover if Q_{T2} of the form mP—though, of course, if m=1, this will be apparent). To this end, the point Q_{T2} is required to be derived from an identifier string ID_{T2} for T2 using the mapToPoint function H₁ because in this case even if Q_{T2} happened to be equal to mP (which is highly unlikely), the second trusted authority T2 would neither be aware of this nor able to separate out m and use it to generate an X of the form s₁s₂mP. It is not, of course, possible for the second trusted authority T2 to work backwards from a value of m to produce the string ID_{T2} that would give rise to m using the mapToPoint function H₁.

Thus:
Q_{T2}=H₁(ID_{T2})
where the identifier string ID_{T2} can be any string and typically, though not necessarily, serves to identify the second trusted authority in plain language. The secret S_{T2} is generated by the first trusted authority T1 from ID_{T2} using its private-key generation functionality 35.

So now if the second trusted authority T2 makes public the string ID_{T2} rather than (or in addition to) Q_{T2}, the first user A can use the string ID_{T2} to form the point Q_{T2} thereby reassuring itself that the second party has not used a value m to form Q_{T2} as mP. However, the first user A also needs to be able to link this legitimate Q_{T2} to the elements used in Test 1—in particular, the user A needs to be sure that the element Y′ contains the legitimate Q_{T2} derived from ID_{T2}. To this end, the user A must carry out a second test for which purpose the second trusted authority must provide a further quantity, herein called Z (and not to be confused with the earlier use herein of the non-italicised Z for the set of all integers), that is equal to s₂P. The element which the user A actually receives and is purportedly Z, is designated Z′. The second test is of the following form:
p(Z′, Q_{T2})=p(P, Y′) Test 2

If this is true, then the user A knows that Y′ must contain Q_{T2}.

The above test (Test 1) is now therefore adequate to prove that the second trusted authority T2 does indeed have a secret of the form s₁Q_{T2} which must have been provided by the first trusted authority T1, thereby proving there is an association between the first and second trusted authorities.

It may be noted that P could be based on an identity string for the first trusted authority T1 by using the mapToPoint hash H₁.

The foregoing embodiment was an example of where it was necessary for a trusted authority (in that case, a non-root trusted authority in an hierarchy of trusted authorities) to generate its public point from an identifier in order to demonstrate that it was genuine and not a malicious party acting as a trusted authority. The embodiment to be described below with reference to FIG. 4 is an example of where two independent trusted authorities must generate their public points from respective identifiers in order to avoid cryptographic weaknesses in the scheme being implemented.

In the FIG. 4 embodiment, four parties are depicted, namely a first user A acting through computing entity 40, a second user B acting through computing entity 42, a first trusted authority T1 acting through computing entity 44 that provides private-key generation functionality 45, and a second trusted authority T2 acting through computing entity 46 that provides private-key generation functionality 47. The computing entities 40, 42, 44 and 46 are typically based around program-controlled processors though some or all of the cryptographic functions may be implemented in dedicated hardware. The entities 40, 42, 44 and 46 inter-communicate, for example, via the internet or other computer network 48 though it is also possible that two, three or all four entities actually reside on the same computing platform. For convenience, the following description is given in terms of the parties A, B, T1 and T2, it being understood that these parties act through their respective computing entities.

The first trusted authority T1 has a public key (P_{T1}, R_{T1})/private key (s₁) key pair where R_{T1}=s₁P_{T1} and s₁ is a secret. The second trusted authority T2 has a public key (P_{T2}, R_{T2})/private key (s₂) key pair where R_{T2}=s₂P_{T2} and s₂ is a secret.

The users A and B are registered with the trusted authorities T1 and T2 respectively. The user A has an IBC public/private key pair formed by a public identifier ID_{A} and a private key S_{A} provided by the private key generation functionality 45 of T1 where:
S_{A}=s₁Q_{A} and Q_{A}=H₁(ID_{A})

Similarly, the user B has an IBC public/private key pair formed by a public identifier ID_{B} and a private key S_{B} provided by the private key generation functionality 47 of T2 where:
S_{B}=s₂Q_{B} and Q_{B}=H₁(ID_{B})

A signcryption scheme is used for sending a message ‘msg’ from user A to user B. This scheme uses two further hash functions H₂ and H₃ with co-domains Z*ₗ and {0,1}^{k}^{₀}^{+k}^{₁}⁺ⁿ respectively. Here k₀ is the number of bits required to represent an element of G₁; k₁ is the number of bits required to represent an identity; and n is the number of message bits to be signed and encrypted; these are global publicly-known parameters.

In the following, the notation u ε_{R} V is used to denote u being selected uniformly at random from the set V.

As already indicated, in this scheme not only do the two trusted authorities choose their secrets s₁ and s₂ ε_{R} Z*_{q}, but they also choose their points P_{T1} and P_{T2}. In order to avoid cryptographic weakness arising from these two points being easily related, the points are derived from respective identity strings, ID_{T1} and ID_{T2} of the trusted authorities T1 and T2. Thus:
P_{T1}=H₁(ID_{T1}) and P_{T2}=H₁(ID_{T2}).

In carrying out the signcryption scheme, user A performs a signing task SIGN 50 followed by an encryption task ENCRYPT 51, and user B subsequently performs a decryption task DECRYPT 54 followed by a verification task VERIFY 55. These tasks are described below:

Sign

User A with identity IDA signs msg using SA
1. Generate r ε_{R} Z*ₗ
2. Compute X₁=rP_{T1} and X₂=rP_{T2}
3. Compute h₁=H₂(X₁, X₂, msg)
4. Compute J=rR_{T1}+h₁S_{A}
5. Forward (msg, r, X₁, X₂, J) to Encryption operation
   Encrypt

User A with identity IDA encrypts msg using output of Signing operation and identity ID_{B} of intended recipient B
1. Q_{B}=H₁(ID_{B})
2. w=p(Q_{B, rR}_{T2})
3. Compute f=H₃(w)⊕(J∥ID_{A}∥msg)
where ∥ represents concatenation and ⊕ the Exclusive OR function
4. Return encrypted message (X₁, X₂, f)
   Decrypt

User B with identity ID_{B} decrypts (X₁, X₂, f) using S_{B}
1. Compute w=p(S_{B}, X₂)
2. Recover J∥ID_{A}∥msg=f⊕H₃(w)
3. Forward msg, (X₁, X₂, J) and ID_{A} to Verification operation.
   Verify

Verify signature (X₁, X₂, J) of A on message msg
1. Compute Q_{A}=H₁(ID_{A})
2. Compute h₁=H₂(X₁, X₂, msg)
3. If p(P_{T1}, J)=p(R_{T1},X₁+h₁Q_{A}) and p(X₁, P_{T2})=p(P_{T1},X₂) accept Else, reject.
   Note that the second equation of item 3 above is used to check if the signer and the encryptor are the same entity. If this issue is not concerned, this equation can be ignored.

It will be appreciated that the order of concatenation carried out in item 3 of the encryption task is not important provided it is known to both A and B; indeed, any reversible deterministic combination function can alternatively be used, the function being reversed in item 2 of the decryption task. Similarly, in computing hi in item 3 of the signing task and item 2 of the verification task, the elements subject to H₂ can be combined in any deterministic manner including, but not limited to, concatenation. Furthermore, the encryption of the message in item 3 of the encryption task which here is carried out using an XOR function with w effectively serving as a symmetric key, can be replaced by any other suitable symmetrical-key encryption function using w as the key.

Although in the foregoing description of FIG. 4 embodiment both trusted authorities are described as deriving their respective points P_{T1} and P_{T2} from identifier strings, in fact it would be possible for one trusted authority simply to independently pick its point provided it can be sure that the other trusted authority forms its point from an identifier string.

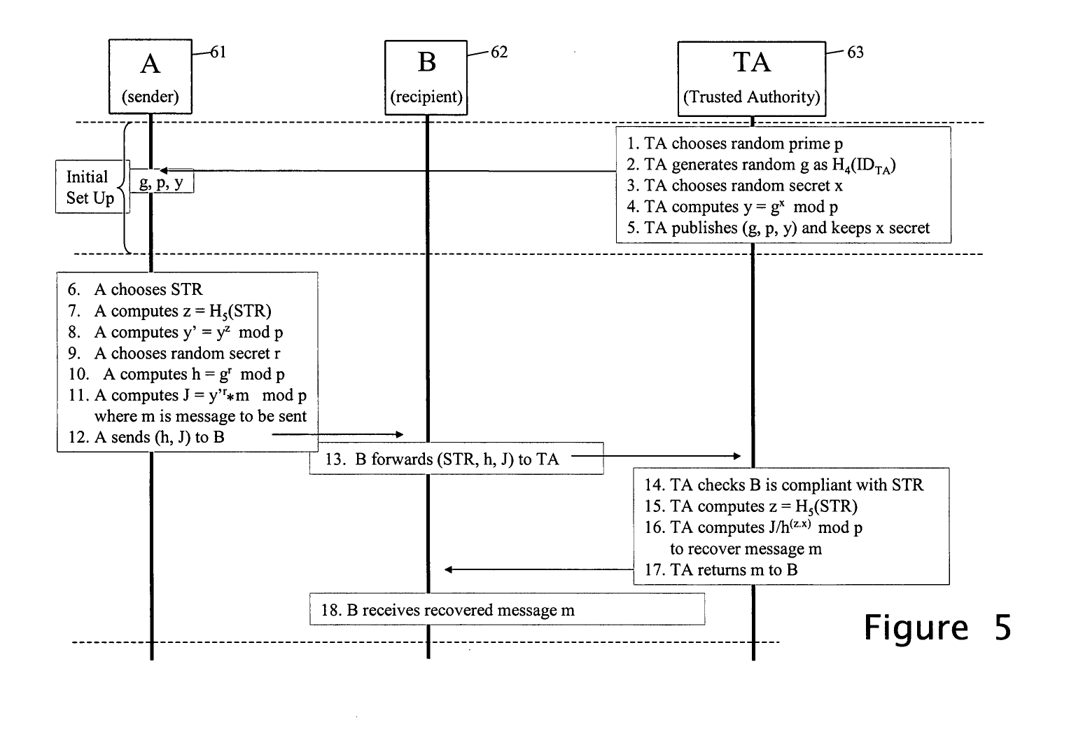

The foregoing embodiments all concern identifier-based cryptography using bilinear maps; however, it is also possible to apply the invention to trusted authorities involved in identifier-based cryptography implemented using an approach other than bilinear maps. For example, in the case of ElGamal identifier-based encryption as described in the reference mentioned above, the generator ‘g’ formed by the trusted authority can be derived from a hash of an identifier string associated with the trusted authority (a hash being a one-way function). FIG. 5 depicts such a version of the ElGamal identifier-based-encryption method and involves three parties, namely a message sender A acting through computing entity 61, a message receiver B acting through computing entity 62, and a trusted authority TA acting through computing entity 62. As with the other embodiments, the computing entities 61, 62 and 63 are typically based around program-controlled processors though some or all of the cryptographic functions may be implemented in dedicated hardware. Furthermore, the entities 61, 62 and 63 inter-communicate, for example, via the internet or other computer network though it is also possible that two or all three entities actually reside on the same computing platform. For convenience, the following description is given in terms of the parties A, B and TA, it being understood that these parties act through their respective computing entities. It is also to be understood that the meanings of the various letter symbols used are specific to this embodiment and should not be confused with the use of the same letter symbols for different quantities in the pairings-based embodiments described above.

In general terms, the TA has a private key x and public keys g, p and y where y=g^{x} mod p and g is derived from an identifier ID_{TA} by use of a hash function H₄. The TA is arranged to decrypt for B a message encrypted by the sender A. The encryption process effected by the sender A involves the use of a sender-chosen “identifier” string (typically, though not necessarily, identifying the intended recipient B). The string is provided to the trusted party TA and is a required component of the decryption process whereby any change in the string will result in a failure to correctly decrypt the message. The detailed steps of the FIG. 5 method are set out below.

Initial Set Up Phase

1. TA chooses random prime p.
2. TA generates g as H₄(ID_{TA}) where g is in the range 2 to (p-1).
3. TA chooses a secret x.
4. TA computes y=g^{x} mod p.
5. TA publishes (g, p, y) and keeps x secret.
   Message Transfer Phase

Message Encryption by Sender A
6. A chooses an identifier string STR.
7. A computes z=H₅(STR) where H₅ is a hash function (for example, SHA-1).
8. A computes y′=y^{z} mod p
9. A chooses a secret r.
10. A computes h=g^{r} mod p
11. A computes J=(y′^{r})·m mod p
12. A sends (STR, h, J) to B and destroys r.
(Steps 8 and 11 can be merged to have A compute J as: (y^{zr})·m mod p)

Message Decryption for Recipient B by Trusted Authority TA
13. B forwards (STR, h, J) to TA.
14. TA checks that B meets the conditions set out in STR.
14. TA computes z=H₅(STR).
15. TA computes J/h^{(z x)} mod p to recover the message m.
16. TA returns message m to B.
17. B receives recovered message m.

The transmissions are preferably integrity protected in any suitable manner. A potential drawback of the FIG. 5 embodiment is that the TA can read the messages m. In order to prevent this, B can blind the encrypted message before sending it to TA for decryption, B subsequently un-blinding the decrypted, but still blinded, message returned by the TA to recover the message m.

It will be appreciated by persons skilled in the art that H₄ should be such that:
g^{q}=1 mod p
where q is a large prime that divides (p-1). A suitable implementation of H4( ) is of the form:
H₄(ID_{TA})=(#(ID_{TA}))^{(p-1)/q}
where # is a hash function such as SHA-1 and #(ID_{TA}) is converted to integer form for raising to the power (p-1)/q.

It will be further appreciated by persons skilled in the art that it is possible for the trusted authorities of other IBC cryptosystems to derive public key elements from their respective identifiers using one-way mapping functions. The applicability or otherwise of this approach to any particular IBC cryptosystem will be readily apparent to a skilled person on inspection having regard to what randomly-chosen key elements, if any, of the trusted authority can be made public.

It will be understood that in the foregoing, reference to a point or other element being public simply means that it is made available to all parties that are authorised to participate in the cryptographic scheme concerned.

1. An identifier-based cryptographic method, comprising a trusted authority, with a secret and an associated identifier string, carrying out operations of:
deriving a first element from said identifier string using a one-way mapping function;
deriving a second element using the secret and the first element;
making at least the second element publicly available; and
providing a private-key generation service comprising generating a private key for a third party in dependence on said secret s and on an identifier string associated with that third party.

2. A method according to claim 1, wherein the first and second elements, and the private keys generated by the private-key generation service, are points on an elliptic curve, the method involving the use of bilinear maps.

3. A method according to claim 1, wherein the method is based on the ElGamal cryptosystem with the second element being of the form:
g^{x} mod p
where g is the first element, x is said secret, and p is a random prime.

4. A method according to claim 3, wherein said mapping function is of the form:
(#(ID_{TA}))^{(p-1)/q}
where: # is a hash function,
ID_{TA} is the identifier string of the trusted authority, and
q is a prime that divides (p-1);
the result of #(ID_{TA}) being converted to integer form for raising to the power (p-1)/q.

5. A method according to claim 1, wherein the identifier string associated with the trusted authority comprises a contact address for the trusted authority.

6. A method according to claim 1, wherein the identifier string associated with the trusted authority comprises data specifying a format to be used for the third-party identifier strings.

7. A method according to claim 1, wherein the trusted authority is independent of any other trusted authorities involved in the cryptographic method.

8. A method according to claim 1, wherein the trusted authority is otherwise than a non-root trusted authority of a hierarchy of trusted authorities.

9. A method according to claim 8, wherein the trusted authority is the root trusted authority of a hierarchy of trusted authorities.

10. A method according to claim 1, wherein the trusted authority is a non-root trusted authority in a hierarchy of trusted authorities.

11. Apparatus for use as a trusted authority in respect of identifier-based cryptographic methods, the apparatus comprising:
a store for holding a secret;
a first derivation arrangement for deriving a first element from an identifier string of the trusted authority using a one-way mapping function;
a second derivation arrangement for deriving a second element using the secret and the first element;
a distribution arrangement for making at least the second element publicly available; and
a private-key generation arrangement for generating a private key for a third party in dependence on said secret and on an identifier string associated with that third party.

12. Apparatus according to claim 11, wherein the first and second derivation arrangements and the private-key generation arrangement are respectively arranged to generate said first and second elements and the third-party private keys, as points on an elliptic curve.

13. Apparatus according to claim 11 for use as a trusted authority in an ElGamal-based cryptosystem, the second derivation arrangement being arranged to derive the second element as:
g^{x} mod p
where g is the first element, x is said secret, and p is a random prime.

14. Apparatus according to claim 13, wherein the said mapping function is of the form:
(#(ID_{TA}))^{(p-1)/q}
where: # is a hash function,
ID_{TA} is the identifier string of the trusted authority, and
q is a prime that divides (p-1);
the result of #(ID_{TA}) being converted to integer form for raising to the power (p-1)/q.

15. Apparatus according to claim 11, wherein the identifier string of the trusted authority comprises a contact address for the trusted authority.

16. Apparatus according to claim 11, wherein the identifier string of the trusted authority comprises data specifying a format to be used for the third-party identifier strings.

17. A cryptographic system comprising apparatus according to claim 11, wherein the apparatus is arranged to serve as a trusted authority that is independent of any other trusted authorities involved in the system.

18. A cryptographic system comprising apparatus according to claim 11, wherein the apparatus is arranged to serve as a trusted authority that is otherwise than a non-root trusted authority of a hierarchy of trusted authorities.

19. A system according to claim 18, wherein the apparatus is arranged to serve as a root trusted authority of a hierarchy of trusted authorities.

20. A cryptographic system comprising apparatus according to claim 11, wherein the apparatus is arranged to serve as a trusted authority that is a non-root trusted authority in a hierarchy of trusted authorities.

21. A computer program product for conditioning programmable apparatus to provide a trusted authority for identifier-based cryptography, wherein the trusted authority comprises:
a store for holding a secret;
a first derivation arrangement for deriving a first element from an identifier string of the trusted authority;
a second derivation arrangement for deriving a second element using the secret and the first element;
a distribution arrangement for making at least the second element publicly available; and
a private-key generation arrangement for generating a private key for a third party in dependence on said secret and on an identifier string associated with that third party.
